(19) United States
(12) Patent Application Publication
(10) Pub. No.: US 2012/0158192 A1
(43) Pub. Date: Jun. 21, 2012

(54) Apparatus for Monitoring and Controlling Material Handling System Operations

(75) Inventor: Randall L. Sherwood, Suisun, CA (US)

(73) Assignee: SPILLGUARD TECHNOLOGIES, INC., Benecia, CA (US)

(21) Appl. No.: 13/407,207

(22) Filed: Feb. 28, 2012

Related U.S. Application Data
(63) Continuation of application No. 12/406,595, filed on Mar. 18, 2009.
Application No. 12/406,595 is a continuation-in-part of application No. 10/993,004, filed on Nov. 18, 2004, now abandoned.
Application No. 10/993,004 is a continuation-in-part of application No. 09/877,958, filed on Jun. 8, 2001, now Pat. No. 6,931,305.

(51) Int. Cl. G05D 7/00

(52) U.S. Cl. 700/282

(57) ABSTRACT

A SIS-SCS for a fluid transfer facility has a connective interface providing signal connectivity to overfill and ground circuitry in individual fill lanes, to pump and valve control circuitry, and to individual ones of input mechanisms, and executable software routines for monitoring input at the connective interface, and for providing output signals through the connective interface to external devices and equipment including at least the pump and valve control circuitry, the input mechanisms for input of fill parameters, and to the one or both of overfill and ground monitoring circuits.

### RELATED APPLICATIONS

This application is a continuation of copending U.S. patent application Ser. No. 12/460,595, filed on Jul. 21, 2009, which is a continuation-in-part of copending U.S. patent application Ser. No. 10/993,004 filed on Nov. 18, 2004, which application claims the benefit of U.S. Pat. No. 6,931,305, issued on Aug. 16, 2005; the entire contents of these patents and patent applications are hereby incorporated by reference in their entirety.

### FIELD

The present invention is in the field of material transfer control systems, and has particular application in the area of monitoring components of such systems, and in providing protective controls.

### BACKGROUND

The need for safe and efficient storage, delivery and transport of petrochemical or other types of solid, liquid or gaseous materials has driven large investments in engineering technology that has improved these processes. Current systems for storage, transport, and delivery of these types of materials employ state-of-the-art electronic equipment for monitoring and controlling, for example, pump operations.

While the standard methods of transferring product are described with reference to a load lane used for petroleum product transfers, those of ordinary skill in the art will recognize that similar processes and analogs of the specifically described petroleum product transfer equipment used in other material transfer are well known in the art.

Currently, most applications employ these types of monitoring and control systems as separate monitoring and control units. For example, a typical load lane for petroleum product transfer uses separate units for overfill detection, vehicle static grounding verification, and vapor recovery systems. These separate units monitor various functions and conditions for normal, safe, or sanitary operation and can interrupt material flow if those conditions are not met. These separate systems are open loop systems that don't verify that intended actions were acted upon or completed. Separate sets of such units monitor sensors on the mobile tank, and for the base and delivery pump and valve operations, typically mount, sometimes with additional other monitoring or control units, on a loading rack located remotely from the pumping and metering area.

An abnormal condition in either the fluid flow system, vapor recovery system, or grounding condition generates signals that the monitoring and control units receive and consequently these units remove command signals that allowed fluid flow. For example, a preset may allow fluid flow by sending a control voltage or energizing voltage to a control valve or to a relay controlling the power to a pump. But when the inputs to the preset correspond to an abnormal condition, that control or energizing voltage is removed, which causes material flow to cease if the control valve, relay, or pump is functioning correctly or is correctly adjusted. The monitoring and control units interpret the pulsed signals from sensors on the transport vehicle or pump station based on preset information, some of which the driver inputs through a transport-vehicle-driver interface. The preset data assumes that mechanical valves and other equipment are in good condition and are properly tuned and adjusted, and functioning as designed. These separate systems are open loop systems that similarly don't verify intended actions were acted upon or completed.

Whether a preset is of an older mechanical type with electrical output, or is of a more recent electronic design handling multiple pump components, its lack of positive control over, for example, an improperly adjusted or otherwise malfunctioning control valve, for example, can create an environmental hazard due to the high fluid-flow rate and pressure of the material flowing through the valve. In current systems, a valve failure in one lane may present a hazard to other nearby operating pumping lanes. These nearby lanes may have separate sets of pumps, valves, and controllers from which they're served. Because the separate sets of controllers monitoring a lane typically receives no indication of the nearby hazard, they will continue to operate normally under the hazardous conditions presented by the malfunctioning lane.

In current systems, the preset values and parameters for loading assume that all of the valves, meters, and other equipment are adjusted, tuned, and functioning properly. But when a control valve is out of adjustment or does not function properly for whatever reason, an overfill condition is possible. For example, when a driver of a tank vehicle enters data into the preset interface, the capacity and overfill sensing point of the destination compartment defines the amount of material destined for the compartment. If a driver erroneously enters such preset data, or if a control valve is misadjusted or has failed, the error is unknown to the preset and the monitoring and control system may not be able to shut down the pump and valve quickly enough to avoid a spill, once an overfill signal from the probe is received.

Another problem can arise in current systems using an electronic preset in the area of leakage detection for control valves. For example, if the preset has undergone recent maintenance without proper reconfiguration to provide the correct alarm when leakage occurs, the leakage may not be detected, resulting in product loss. Similarly, intentional leakage, that is, theft, will be undetected by the preset, as well.

For safety, petroleum or petrochemical product storage and transfer operations should function to globally shut down pumping and loading operations quickly if an abnormal or hazardous condition such as overfill or static ground loss exists. It is also desirable to be able to detect a slow leak in one of several operating pumps that are monitored and controlled by a shared monitoring and controlling unit, particularly when an electronic preset is not properly configured for providing a leakage alarm signal to the monitoring and controlling units. It is also desirable to know when there is no flow despite a command to flow; this may indicate a loss of communications with the product meter or a catastrophic product meter failure.

What is needed is a fail-safe method and apparatus for monitoring and controlling various critical aspects of material transfer operations, having global control over either or both of the storage and delivery systems, and providing that control much faster than current monitoring and controlling systems can do so. This method and apparatus would provide comprehensive, centralized interpretation of operational pulsed signals or normal operating parameters, such as static ground, would detect product overfill conditions or leakage, would protect the operation of vapor recovery systems, or would notify management when a problem in the pumping or delivery system occurs. Such an improved monitoring and controlling apparatus could continually monitor several individual meter pulses and pump commands simultaneously, and would interface or connect to most modern electronic monitoring and control systems currently employed in the field, and could also be configured to be compatible with a variety of other modern monitoring and control systems and vapor recovery systems.

### SUMMARY

In an embodiment of the present invention, a supervisory independent secondary shutoff control system unit (SIS-SCS) is provided for a fluid or material transfer facility. This unit provides supervisory functionality in that it monitors the fluid or material transfer process and has the functionality to shutoff or shutdown material or fluid flow. This unit provides its monitoring and shutoff functionality independently of the primary controls for the fluid or material transfer process including appropriately stopping fluid or material flow even when the primary system fails or fails to stop fluid or material flow appropriately. The unit provides its functionality secondarily to the primary control system.

The fluid flow facility comprises one or more remote product storage tanks; a base valve; a product pump and a flow-control valve in fluid conduits leading from individual remote storage tanks to one or more fill lanes; pump and valve control circuitry dedicated to controlling the pumps and valves, fill lanes having an input mechanism for input of fill parameters; and one or more of overfill, ground monitoring, or vapor recovery monitoring circuits connectable to mating connectors and sensors on a vehicle to be filled in a lane. The SIS-SCS 1250 has a connective interface providing signal connectivity to the overfill, ground, preset, pump controls, and vapor recovery circuitry in the fill lanes. The vapor recovery units primarily do not have sensors in place to test for pressure and volume, etc. If the vapor recovery unit is asked to process too much vapor, it can and does allow pressure to build up to a point where tank compartments become over pressurized. Some embodiments of the SIS-SCS 1250 monitor the vapor recovery units to prevent over pressurization of tank compartments. The connective interface also provides signal connectivity to the pump and valve control circuitry, and to individual ones of the input mechanisms. The SIS-SCS 1250 also contains executable code for accepting and monitoring input at the connective interface and for providing output signals through the connective interface to external devices and equipment, including at least the pump and valve control circuitry, the input mechanisms for input of fill parameters, or to one or more of overfill, vapor recovery, or ground monitoring circuits. The unit through its SIS-SCS, continually executes software routines, monitors conditions of the overall system, and automatically inhibits flow of fluids for specific, abnormal, pre-programmed conditions as monitored at the connective interface.

In some embodiments, one or both of input and output signals to and from remote equipment and the SIS-SCS 1250 are accomplished via a wireless communication system. In some embodiments the wireless communication system is an RF system, using RF transmit and receive equipment in the SIS-SCS 1250.

In certain embodiments of the monitoring and control unit, the output signals include alert signals to remote alert equipment. The SIS-SCS 1250 sends alert signals responding to conditions of the overall system through execution of software routines. The alert equipment can include one or both of audio and visual alert devices located throughout the material transfer facility.

In some embodiments, there is a display for status and conditions of the fluid transfer facility. The display may include ground conditions at fill lanes, and real-time flow rates in individual ones of the fluid conduits of the fluid transfer facility. In some cases, there is at least a red and a green visual alert indicator for providing a general indication of the status of conditions in the fluid transfer facility. In addition, there may be one or more manual inputs for immediate shutdown of one or more functions in the fluid transfer facility.

In the various embodiments of the invention described in enabling detail below, for the first time a general and comprehensive intelligent system is provided to enhance the efficiency, accuracy and safety of material transfer operations in material transfer facilities, in particular those that transfer explosive and hazardous materials, such as fuel products.

### BRIEF DESCRIPTION OF THE DRAWING

The features, aspects, and advantages of the invention will become more thoroughly apparent from the following detailed description, appended claims, and accompanying drawings.

FIG. 1 is block diagram of a simple material transfer system.

FIG. 2 is a block diagram showing the interaction of an embodiment of the invention with the material transfer system.

FIG. 3 is a simplified block diagram of a typical fluid transfer operation and electronic monitoring and control system.

FIG. 4 is a block diagram of a fluid transfer operation and electronic monitoring and control system and a control monitor unit according to an embodiment of the present invention.

FIG. 5 is a diagram showing a vapor recovery system of a material transfer facility.

FIG. 6 is a flow diagram illustrating logic of firmware routines of SIS-SCS 1250 in an embodiment of the invention.

FIG. 7 is a flow diagram illustrating additional logic of the firmware routines of SIS-SCS 1250.

FIG. 8 is a flow diagram illustrating additional logic of the firmware routines of SIS-SCS 1250.

FIG. 9 is a flow diagram illustrating additional logic of the firmware routines of SIS-SCS 1250.

FIG. 10 is a flow diagram illustrating additional logic of the firmware routines of SIS-SCS 1250.

FIG. 11 is a block diagram showing a prior art version of a tanker connected to an automobile filling station.

FIG. 12 is a block diagram showing a tanker connected to an automobile filling station.

### DESCRIPTION

The following description of several embodiments describes non-limiting examples that further illustrate the invention. All titles of sections contained herein, including those appearing above, are not to be construed as limitations on the invention, but rather they are provided to structure the illustrative description of the invention that is provided by the specification.

Unless defined otherwise, all technical and scientific terms used in this document have the same meanings as commonly understood by one skilled in the art to which the disclosed invention pertains. The singular forms a, an, and the include plural referents unless the context clearly indicates otherwise. Thus, for example, reference to “fluid” refers to one or more fluids, such as two or more fluids, three or more fluids, or even four or more fluids.

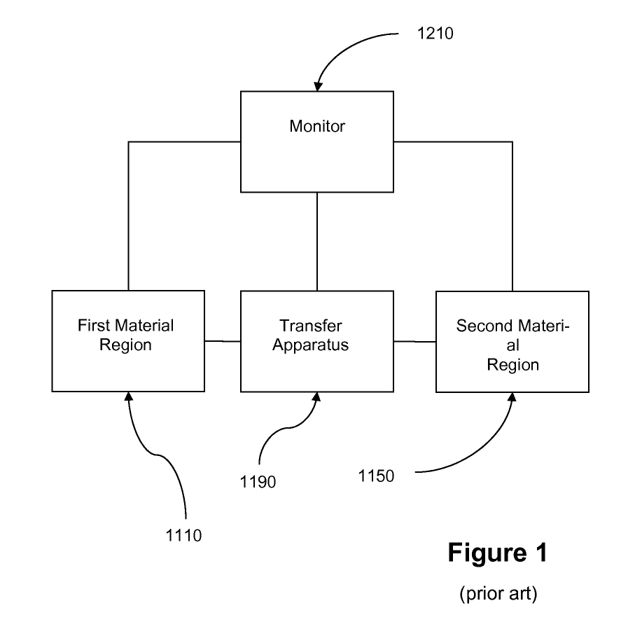

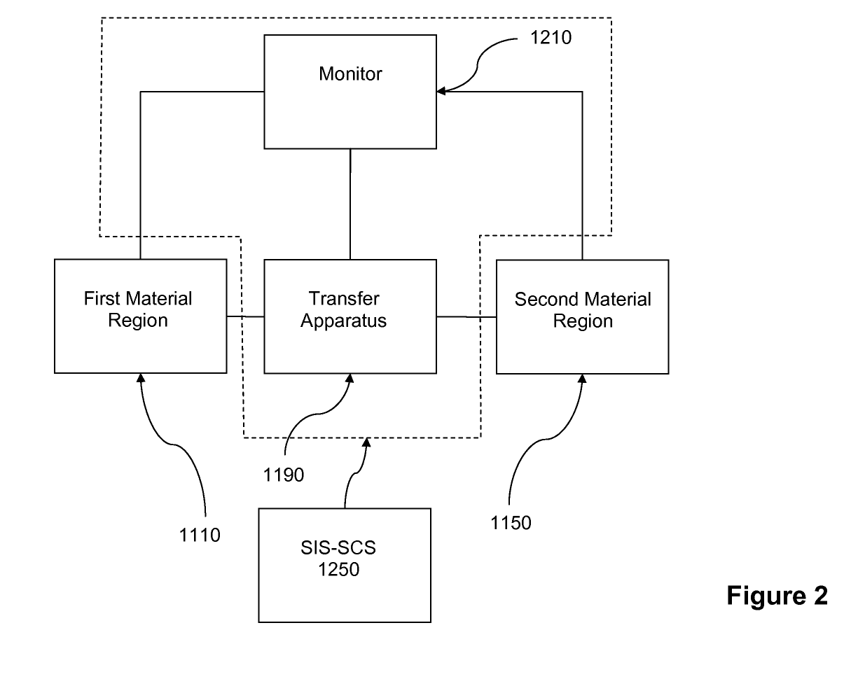

In general, the current invention relates to providing supervisory control over a material transfer process or a material transfer system. As shown in FIG. 1, prior art material transfer processes are processes that move material from a first container or region 1110 to a second container or region 1150 along a transfer route using a transfer apparatus 1190. Material transfer processes occur throughout industry and vary widely depending upon the identity of the material, the first and second containers, and the transfer route. Despite these differences, each material transfer process contains common elements, as well. For example, each material transfer process includes a monitor 1210 for monitoring the conditions of the material before, during, or after the transfer, a way of monitoring how much material has been transferred, or a way of monitoring safety or environmental conditions before, during, or after the transfer. Some invention embodiments comprise devices that interface to the preexisting or primary transfer process components, such as transfer apparatus 1190 or monitor 1210, to provide master (or supervisory) monitoring or master control of the transfer process to circumvent any damage or sub-optimal effect of a malfunction or an abnormal condition in the primary controls or components of the material transfer process or system. FIG. 2 represents the portion of the prior art material transfer system that some embodiments of the SIS-SCS 1250 control.

For instance, if a prior art material transfer process transfers soil from a pile into a dump truck using a conveyor belt system, the transfer consists of determining how much soil to move to the truck, determining how much soil has been moved to the truck during the transfer, determining when to start the transfer, determining when to stop the transfer, and insuring that environmental controls operate during the transfer. These steps fall under the control of monitor 1210. (As a point of reference, monitor 1210 may or may not be a specific device in the prior art. Nonetheless, the general functionality described as part of monitor 1210 is functionally present generally in one form or another in prior art processes) For purposes of discussion, the truck sits on a scale (also part of the monitor 1210) during the filling process. The soil pile would correspond to the first material region 1110. The dump truck would correspond to the second material region 1150. The conveyor belt is part of the transfer apparatus 1190. Also, for purposes of discussion, the environmental controls could be a misting system that moistens the soil during transfer to combat dust generation. The misting system is also part of the transfer apparatus 1190. The primary controls of a prior art system could check to see if material transfer has been requested, a truck is in place, and the misting system is running before allowing the motor on the conveyor system to operate.

While the primary system is capable of starting and stopping the conveyor system at the correct times, current systems sometimes lack failsafes or other monitoring functionality to prevent spills or environmental releases. For instance, a prior art system may determine that the misting system is operational because the pump supplying that system indicates that it is on or pumping. Or the primary control system may determine that the system is not currently transferring material because it has sent a stop signal to the motor control for the conveyor system. Or the primary system may respond to a start command by starting without a truck positioned at the receiving point. For example, either of these conditions could result in a malfunction that would be unknown to the primary control system or monifor 1210 and thus beyond the primary control system's ability to control or respond to.

On the other hand, some embodiments of a SIS-SCS 1250 could have software routines to test for the truck at the receiving position. If the monitor 1210 (primary control system) attempted to begin soil transfer at a time in which the receiving truck was not in the receiving position, the SIS-SCS 1250 could cut the power to the conveyor system thereby preventing the soil delivery. Likewise, the monitor 1210 may determine that the conveyor system is currently stopped (because it is sending a stop instruction to the conveyor) in a circumstance in which the conveyor control system has mistakenly been left in the manual control mode (thus inadvertently taking the conveyor out of the control of the primary control system). This would result in material delivery even as the primary control system was sending a stop signal to the conveyor. But the SIS-SCS 1250, if it were configured to monitor the conveyor system, could sense the malfunction or abnormal condition and then trigger a fault related to unauthorized operation of the conveyor system. In this situation, the software routines of the SIS-SCS 1250 could alert the operator of the facility, could cut power to the conveyor system, or initiate any number of other appropriate measures. For situations using a dust control system (like a mister for damping the soil during the conveying process), embodiments of the SIS-SCS 1250 could be configured to contain a water sensor to measure the degree of misting taking place. If no misting where occurring, but soil was being transferred, the SIS-SCS 1250 software routines could generate a fault related to the malfunction of the dust control system, which could then cause other software routines to execute to end or prevent the environmental dust release.

In an alternative embodiment in which the material is a liquid foodstuff such as cooking oil, wine or orange juice, embodiments of the SIS-SCS 1250 can be configured to detect malfunctions, or abnormal conditions, as well. In prior art systems, the transfer process may employ a controller that lacks the ability to determine if the receiving tanker truck is appropriate for carrying edible material. (For instance, the truck may have previously transported poisonous material). Replacing such an existing system to provide this increased functionality would be very costly. But using an embodiment of the SIS-SCS 1250 configured to read an RFID tag on the tanker that indicated that the tanker was unsuitable for food, the SIS-SCS 1250 could cause the system to lock out material transfer to prevent material contamination.

In yet other embodiments in which the SIS-SCS 1250 is configured to load fuel into a tanker for deliver to point of sale locations, such as automobile filling stations, the SIS-SCS 1250 can prevent, among the effects of other malfunctions, the commingling of fuels in the fueling tankers. Again, if the fueling tanker contained an RFID tag indicating the type of fuel contained in the tank and the trucks identification, the SIS-SCS 1250 could query the RFID device and could cause the primary control system (primary monitor) to act to prohibit fuel flow or could directly act to prohibit fuel flow from the facility if the wrong type of fuel had been selected. The SIS-SCS 1250 can also compare the ID of the truck to the loading facility ID and prohibit fuel loading if the truck was not authorized to load fuel at that facility.

In yet other embodiments in which the SIS-SCS 1250 is configured to connect to an airport (or air base) fueling system, the SIS-SCS 1250 can prevent, among the effects of other malfunctions, the commingling of fuels in the fueling tankers. Again, if the fueling tanker contained an RFID tag indicating the type of fuel contained in the tank, the SIS-SCS 1250 could query the RFID device and could cause the primary control system (primary monitor) to act to prohibit fuel flow or could directly act to prohibit fuel flow from the facility if the wrong type of fuel had been selected.

The SIS-SCS 1250 can monitor the performance of material transfer facility to alert the operator to maintenance needs.

An improved method and apparatus is presented by the inventor for reliably and consistently monitoring the operation and condition of critical systems in a fluid transfer operation, systems that may be in the product storage, pumping, delivery, metering or some other area, or for monitoring sensors on a tank vehicle. An SIS-SCS 1250 having the ability to shutdown or otherwise control critical operations can perform such functions in the least amount of time possible to avoid overfill, product or vapor leakage, or unauthorized fluid transfer. Some embodiments of the present invention provide these improvements and enhancements in monitoring and control, and are more thoroughly described below.

While a system used for transferring petroleum products from a storage tanker into the storage compartments of a tank truck is illustrated, the monitoring and secondary control aspects of the current invention are applicable to any transfer of material from one point to another.

In some invention embodiments, the apparatus comprises an SIS-SCS 1250 that interfaces with at least one prior art material transfer stream in a material transfer facility, in which the stream is controlled by a primary controller such as a batch preset 116 or a pump and valve controller 109. The SIS-SCS 1250 through continuous or semi-continuous execution of software routines monitors one or more of the primary monitor 1210, the transfer apparatus 1190, the first material region 1110, or the second material region 1150. This monitoring uses various sensors or communicators that may be part of the prior art material transfer facility or sensors that are added to increase the control and monitoring capabilities of the SIS-SCS. From its programming and from monitoring or communicating with the various sensors or communicators, the SIS-SCS 1250 identifies a normal or steady state set of conditions for the material transfer stream in each of its various operation modes. If at any time the SIS-SCS 1250 detects one or more conditions of the material stream that are outside of the normal or steady-state conditions (stream malfunctions), the system executes software routines that initiate any combination of warning an operator, discontinuing material flow in the stream, discontinuing material flow in parallel streams, or locking out material transfer initiation. These actions will occur despite the control signaling of the batch preset. Hence, the SIS-SCS 1250 operates in an independent, supervisory position.

The term supervisory means that the SIS-SCS 1250 functions to monitor the actual state of the various active devices of the prior art transfer machinery. This is opposed to accepting an indicated condition as the actual condition. For instance, the prior art primary monitor assumes no fluid is flowing because its logic “indicates” that the power to a solenoid is turned off, which would have caused a correctly operating solenoid to close thereby stopping fluid flow. If the solenoid were to stick open, fluid would continue to flow despite the primary monitor's 1210 indication that fluid flow had ceased.

But the SIS-SCS 1250 does not rely on an indicated condition of the active components of the prior art transfer machinery. Instead, the SIS-SCS monitors a flow meter. Flow has not ceased until the SIS-SCS measures a ceased flow. This measuring of a process parameter allows the SIS-SCS 1250 to “supervise” the operation of the prior art machinery.

The term independent means that the SIS-SCS can control the process parameter (or signal based on its value) without relying on the prior art monitors or controllers. For instance, the SIS-SCS could connect to a master shut-off valve to stop fluid flow in the face of a malfunctioning solenoid. There exist many ways of providing this type of control depending upon what process is being controlled.

In this or other embodiments, the material transfer facility has a metering means, safety monitoring means, and environmental monitoring means.

Those of ordinary skill in the art will recognize that many different malfunctions may arise in a material transfer facility. These malfunctions include unauthorized flow, improper grounding (grounding fault), receiver overflow, exceeding vapor recovery system pressure (vapor recovery fault), etc. The SIS-SCS 1250 can monitor for any of these malfunctions and appropriately respond to them using the primary controls that are part of the material transfer facility or using controls added to the facility to allow the SIS-SCS 1250 control over the facility.

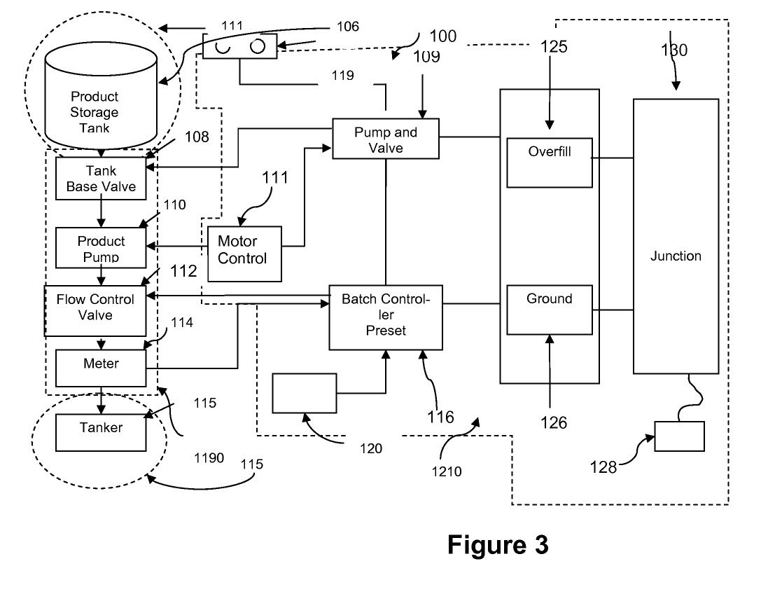

FIG. 3 is a simplified block diagram of a typical fluid transfer monitoring and control system according to the prior art. The first material region 1110 is circled and for this embodiment is a product storage tank 106. The second material region 1150 is circled, as well, and in this embodiment, tanker 115 represents the second material region 1150. Dashed lines surround the transfer apparatus 1190. And the monitor 1210 comprises those components within the dashed oval. System 100 represents a fluid storage and transfer system such as is used for the loading of petroleum or petrochemical products into the storage compartments of a tank truck or rail tank, for example. System 100 has a product storage tank 106, which may be a plurality of storage tanks, each containing a separate fluid product. Each storage tank 106 connects to a transfer apparatus 1190 that is composed of at least a tank base valve 108 serving as the main tank shut-off valve, and a product pump 110 for pumping the product to a terminal in a loading lane where it is transferred into the compartment of the vehicle storage tank. In some systems, additional product pumps may meet the demand of multiple loading lanes simultaneously pumping the same product from the storage tank 106.

Also part of the transfer apparatus 1190 or primary monitor 1210, a pump and valve controller 109 has control circuitry that sends signals for controlling either the tank base valve 108 or the product pump 110, or both, based on a number of different inputs known in the art, some, but not all of which are shown in FIG. 3. Various systems similar to that shown in FIG. 3 may have some or all of the inputs shown. Control signals sent from pump and valve controller 109 within primary monitor 1210 are sent to a motor control 111 having circuitry that controls product pump 110. If all of the necessary signals to pump and valve controller 109 within primary monitor 1210 are not in the proper state, the transfer of fluid from the product storage tank 106 is inhibited or stopped completely by the primary monitor 1210, thereby avoiding a hazardous overfill condition.

In other words, the pump and valve controller 109 operates in an open loop configuration whereby if all inputs into the pump and valve controller 109 are within the correct ranges, the controller 109 permits or allows pumping or material transfer to begin by sending an open or start permissive signal to, for example, a valve or pump motor in a fluid transfer line. If any of the inputs within primary monitor 1210 to pump and valve controller 109 become abnormal or move out of the appropriate range, primary monitor 1210 removes the permissive signal. When this signal is removed tank base valve 108 closes or the motor control 111 stops product pump 110 if the transfer apparatus 1190 operates correctly.

Primary monitor 1210 lacks the ability to monitor the shut down process to ensure that shut down proceeded to the actual cessation of material or fluid flow. While some versions of primary monitor 1210 or components within it known in the art (for example U.S. Pat. No. 5,771,178, assigned to Scully Signal Company) have built in redundant processors to ensure that simple processor failure does not interfere with the ability of the unit to act to remove the signal that permits fuel flow, no prior art systems have the ability to ensure that actual cessation of material or fluid flow occurred. The Scully patent has a pair of processors arranged in a hot backup configuration. If the first processor fails, the second processor can immediately assume control. But this redundancy does not extend to other parts of the system nor are these processors functioning independently.

For instance, all either processor can do to stop material flow is to remove the permissive signal that tells the material flow apparatus to transfer material. The processor of the Scully patent removes the signal by commanding a switch to open. Upon failure of the first processor, the second processor assumes control and removes the permissive signal by commanding the same switch to open: the switch contains a single set of permissive contacts. Any failures downstream from the contacts in that switch are outside of the redundancy supplied by having the hot backup configuration. In fact, failure of the contacts in the switch itself is outside of the redundancy of the processor pair. Therefore, because the processor of the Scully patent merely supplies redundancy up to a point, a single permissive set of contacts, its redundancy cannot be deemed independent control as discussed above. The device of the Scully patent cannot monitor the shut down process to verify that appropriate valves closed or pumps stopped pumping. Furthermore, the device of the Scully patent has no capability to override a malfunctioning valve or pump to unequivocally stop product flow.

This means that actual control of the material flow is dependent on all of the downstream components despite the redundancy of the processors. This dependency precludes a characterization of the second processor as providing supervisory independent secondary shutoff control as that concept is used throughout this disclosure. Moreover, prior art apparatuses do not have the ability to monitor closure of the flow control valve. Once the processor removes the permissive signal, its job is done and the apparatus assumes shutdown happened smoothly. Therefore, this type of prior art system cannot provide secondary, independent shutoff.

As shown in FIG. 3, prior art systems sometimes include a manual system for closing product pump 110 such as pump shutdown buttons 119 located at the loading lane and connected through wiring to pump and valve controller 109. If a hazardous condition exists requiring product pump 110 to be shut down, a condition such as overfill, for example, the activation of pump shutdown buttons 119 serves as an emergency system for shutting down product pump 110. When activated, pump shutdown buttons 119 provide a signal for cutting the power to product pump 110, thereby stopping its operation if the control circuitry acts as designed. In this example, the manual pressing of pump shutdown buttons 119 provide the signal for shutting down product pump 110. An additional manual switch (not shown) is also commonly used for ensuring that the operator, while loading product into a vehicle tank storage compartment, is always present while the fluid transfer is taking place. Such a manual switch is located at the loading terminal, and must be manually held in a closed position by the operator of the terminal pump during the entire fluid loading (or unloading) process.

A flow control valve 112 controls the rate at which the fluid is pumped into the destination compartment of the vehicle tank. Flow control valve 112 responds to upstream pressure from product pump 110, and operates using both a downstream and upstream electric solenoid valve. The downstream solenoid valve has an outlet connected to downstream piping. And under normal conditions when fluid is not being transferred, the down-stream solenoid of flow control valve 112 remains in a closed position. The upstream solenoid of flow control valve 112 is connected to upstream piping connected to the product pump. And in normal conditions when fluid is not being transferred, the upstream solenoid valve is in an open position. Because of the nature of its design, flow control valve 112 in the system shown, and in other similar systems, must be adjusted periodically and routinely in order to ensure that it closes quickly and properly during operation. If flow control valve 112 is out of adjustment, an excessive amount of fluid may pass through the valve once the signal to close the valve is received, thereby creating a hazardous overfill condition. The design of flow control valve 112 and configuration of its upstream and downstream solenoid valves inadvertently allows a terminal pump operator to slowly bleed product from the system. Such product theft may remain unknown by management and undetectable by the system.

The operation and flow rate of flow control valve 112 is controlled by a batch controller preset 116, which is part of primary monitor 1210. Batch controller preset 116 has circuitry for controlling flow control valve 112 (part of transfer apparatus 1190) and for monitoring pulsed signals from a flow meter 114 that measures the amount and rate of product flow from the flow control valve 112. In various examples of systems such as system 100, batch controller preset 116 may be of an older mechanical design or of a current electronic design having intelligence provided by programmable firmware or the like. A separate flow control valve 112 and flow meter 114 is associated with each product storage tank, tank base valve, and product pump. During the fluid transfer operation, flow meter 114 provides pulsed signals to the batch controller preset 116 for monitoring and analysis. Batch controller preset 116 has intelligence provided by an internal processor and contains data pertaining to system operation, adjustment, and mechanical condition of pumps and valves, as well as other pertinent system information. The driver of the tank vehicle may manually enter additional data such as vehicle tank compartment storage capacity or driver or vehicle identification, or other data pertaining to the loading operation into batch controller preset 116.

In a typical prior art system such as is shown by FIG. 3, the batch controller preset 116 may have multiple components controlling a number of separate products and associated product storage tanks, valves, and pumps. For reasons of simplicity, only one batch controller preset and only one set of product storage, valves, pumps, and meter are shown in this figure. But each loading lane in a typical storage and pump operation such as shown may have multiple sets of components that supply multiple products, allowing an operator to load multiple separate products into separate compartments of a vehicle storage tank simultaneously in one loading lane. In this example the vehicle storage tank, which may contain multiple storage compartments of varying capacity, is represented as tanker 115. In some modem petroleum or petrochemical pumping and loading operations, as many as eight separate sets of components may exist serving a given loading lane. Of course, one of ordinary skill in the art recognizes that the number of sets of components for each lane could be much greater if the proper set of circumstances so dictate.

In operation, the batch controller preset 116 sets the amount of material to be delivered. The pre-set 116 initiates fluid flow by sending a signal to, for example, a flow control valve 112 to open. The pre-set then, by monitoring a (flow) meter 114, delivers the amount of fluid the operator called for and then removes the permissive signal to the flow control valve 112, which should cause the flow control valve 112 to close. The SIS-SCS 1250 detects the signal to begin fluid flow and begins to monitor meter 114 or a separate flow meter to test to see if flow began. If the SIS-SCS 1250 does not detect a flow during this flow-on condition, the SIS-SCS can signal a fault.

The SIS-SCS 1250 also detects the removal of the permissive valve-open signal. While the prior art, primary monitor 1210 assumes that the valve closed upon removal of the permissive signal, the SIS-SCS 1250 instead monitors the flow meter to verify that the valve closed. Moreover, the SIS-SCS 1250 has the functionality to be calibrated to the specific flow control valve 112. For instance, the SIS-SCS 1250 can monitor the closure time of the flow control valve 112 to get a baseline value for the time the valve takes to close. (In some embodiments, this is determined by measuring the rate of change of the flow using data from the flow meter). Once the baseline value has been recorded, the SIS-SCS 1250 can determine within 100, 200, 300, 400, 500, 600, 700, 800, 900, or 1000 milliseconds whether the flow control valve 112 is closing fast enough to meet its base-line performance. This is the SIS-SCS 1250 acting in its supervisory and independent monitoring mode. If the flow control valve 112 is far enough outside of its normal closure behavior, the SIS-SCS 1250 can close another valve or cut power to a pump to prevent excess fluid flow from the system. This is the SIS-SCS acting in its independent control mode.

In a prior art example with additional safety equipment incorporated into the storage and pumping operation represented by system 100 and connected to pump and valve controller 109 and batch controller preset 116, the safety equipment provides a system for monitoring the operational status, flow properties, and other conditions of the system operation, as well as those of the receiving tank vehicle or tanker. An overfill detection unit 125 is connected by wiring to pump and valve controller 109 having circuitry that provides output control signals to motor control 111 that, in turn, controls the operation of product pump 110. Overfill detection unit 125 is also connected to batch controller preset 116, either through pump and valve controller 109 such as shown in this figure, or possibly by direct connection through other circuitry in other systems. Overfill detection unit 125 is used for detecting an overfill condition, typically that of a top or bottom loading tank vehicle, and provides output control signals to various components of the loading operation.

In prior art system 100 pulsed signals continuously check system operation of the pump and valve controller as well as wiring, connections and sensors on the tank vehicle, and are continuously monitored by overfill detection unit 125. Overfill detection unit 125 is designed to be connected to the tank vehicle using a plug assembly 128 comprising a cable and plug that is designed for standard connection to a receptacle on the tank vehicle, and in this example is connected to overfill detection unit 125 through a junction 130. Junction 130 is a standard junction box containing a terminal board for interconnecting one or more monitoring or control units. Pulsed signals from fluid level sensors in different storage compartments of the tank vehicle are monitored by overfill detection unit 125 through the connection to the tank vehicle as described. If an overfill sensor comes in contact with liquid, or a failure occurs somewhere in the system, the pulsed signals will cease, causing overfill detection unit 125 to interrupt the power to pump and valve controller 109 and batch controller preset 116, or otherwise signal for the shutdown of the fluid loading operation, thereby shutting down pumps, valves, terminal systems and possibly other components or systems.

A particular safety concern for tanker loading processes is electric discharges near flammable fluid, such as petroleum, during transfer, and is addressed by constantly maintaining a common ground between the truck and the loading terminal maintained during the loading process. Static ground verification is provided by a ground verification unit 126 having circuitry that verifies the common ground and stops the fluid flow if the ground is lost by cutting power to either or both pump and valve controller 109 and batch controller preset 116. Ground verification unit 126 has connectivity to pump and valve controller 109 and batch controller preset 116, similarly to that of overfill detection unit 125, and is similarly connected to plug assembly 128 through junction 130 for connection to the receptacle on the tank vehicle.

In this example one control unit may provide monitoring and control of pump and valve operation for the product storage system using a set of interconnecting circuitry that is auxiliary to or different from the circuitry connected to terminal pump operations in the load lane. In some other cases, one set of circuitry may be used for connecting one control unit to the components it serves, while a different set of circuitry may be used for connecting a second control unit to the components it serves.

In the prior art process represented in FIG. 3, overfill detection unit 125 and ground verification unit 126 are contained within an industry standard protective enclosure, and are mounted with junction 130 at the loading rack or fill station, near the loading location of tanker trucks during a loading operation. The mounted control monitors and junction are close enough for connecting a plug assembly 128 between junction 130 and the sensor receptacle of the tank vehicle. In the example given for system 100, overfill detection unit 125 monitors signals from a plurality of fluid level sensors, so that it may simultaneously monitor multiple compartments of a tanker vehicle during transfer of several different products.

If in a petroleum or petrochemical fluid transfer operation an overfill or ground-loss situation occurs it endangers adjacent loading lanes, continuing to load after the malfunction and shutdown of the lane with the overfill.

In an inventive embodiment in which the SIS-SCS 1250 attaches to a material transfer system contains a vapor recovery system such as a tanker filling system, the SIS-SCS 1250 can monitor the vapor recovery process, as well. The vapor recovery system can sense that it has the appropriate operating conditions within the recovery system, which typically consist of a reduced pressure. The vapor recovery system functions to recover vapor. When the material transfer facility is a fuel depot, the vapor recovery system recovers fuel vapor, which typically fills the fuel compartment of a tanker. Filling the tanker compartments with fuel displaces this vapor. To prevent the environmental release of the vapor, the tanker has a system that connects each of its fuel compartments to a tanker-borne port that an operator attaches to the facility's vapor recovery system with a hose. Vapor recovery systems or units (VRU) typically accept vapor only. They are configured with a filter or flash-arrestor on the input or inlet side that prevents solids or liquids from entering the system.

The VRU operates in combination with equipment on the tanker. The tanker has one or more pressure relief valves set to relieve pressure to atmosphere if the pressure in the tanks exceeds a pre-set value. Sometimes statutes mandate these pre-set values.

A common failure of a petroleum fluid filling system is the malfunction of the fill or overflow sensor present in the fuel compartments. The malfunction can be the simple non-operation of a broken sensor or the intentionally or unintentionally bypassing of the sensor. In either case, this malfunction can allow excess fuel to be supplied to the fuel compartment. This excess fuel can enter the vapor recovery system of the tanker and the hose that connects the tanker's recovery system with the facility's vapor recovery system. While the facility's vapor recovery system, because of its flame-arrestor, will prevent unwanted material from entering the facility's recovery system, this excess fuel can cause a significant rise in pressure and can cause a spill from the tanker compartment manhole cover. Furthermore, disconnecting the vapor recovery hose will result in the environmental release of the liquid fuel.

But the SIS-SCS 1250 comprising a pressure transducer placed between the tanker-borne port and the vapor recovery inlet can detect the malfunction of the fill sensor because liquid fuel leaking into the vapor recovery system will cause an abrupt pressure rise (referred to as a spike throughout this document) to register on the sensor. Upon detecting such a spike, the SIS-SCS 1250 can alarm, shut down fuel flow, or both, thereby eliminating the environmental release or significantly reducing the extent of the environmental release. Also, unwanted material in the tanker's vapor recovery system can be sucked against the flame-arrestor when the systems are connected. This can prevent the vapor recovery system from achieving the correct operational pressure in the hose or in the tanker. With this type of malfunction, the SIS-SCS 1250 of some invention embodiments, when configured with a pressure transducer as described above, senses the pressure fault and does not initialize fuel flow into the tanker. The SIS-SCS 1250 can be configured to command the preset to perform an orderly fuel shutdown when conditions warrant a shut down. It can then monitor the rate of shutdown according to the normal procedure used by the preset, and initiate an emergency shutdown, if desirable.

Another situation that can cause over pressurization of all compartments being loaded causing the VRU to become over pressurized is too many products being loaded at one time. Too many simultaneous product loadings can exceed the VRU's processing ability consequently causing a significant increase in VRU pressure. The over pressurization of the compartments will cause the compartment's pressure release system to release pressure or cause the tanker compartment's manhole hatches to unseal. This ultimately results in an environmental fuel vapor release at the load line or as the truck is hauling fuel from one point to another. But the SIS-SCS 1250 equipped with a pressure transducer can either shut down filling upon detecting the over pressurization or can temporarily delay filing at one or more stations to alleviate this type of problem.

While the pressure sensor described above can detect liquid in the vapor recovery hose, other methods of detecting liquid in the hose are equally suitable. For instance, a heat-based or an optics-based detection system can function as the liquid detection system, as well. Examples of heat-based systems include thermistor, thermocouple, or diode-based systems.

Prior art systems, such as the ones described above in the Scully patent, can monitor a vapor sensor in the vapor recovery system or unit. Prior art systems use the vapor sensor to verify that the vapor recovery hose is properly connected to the tanker vapor recovery system. If the system commands fuel flow and measures no vapor in the vapor recovery unit, it assumes that the vapor recovery hose is not properly connected and that this misconnection is allowing fuel vapor to escape into the atmosphere. No prior art systems feature an SIS-SCS 1250 that monitors the vapor recovery system for the presence of liquids or for pressure level.

Typically, VRUs operate at pressures lower than 18 inches of water (0.044 atmospheres). The SIS-SCS 1250 of the current invention can be adapted to trigger an alarm or fuel shut down at any desired value. The SIS-SCS 1250 of the current invention can be adapted to trigger an alarm at one pressure and a fuel shut down at a different pressure. Typically, the maximum allowable pressure is defined by statute. But the SIS-SCS 1250 of the current invention can be set to respond to pressures over 24, 20, 18, 16, 14, 12, 10, 8, or 6 inches of water or can be set to respond to any pressure range bounded by a pair-wise combination of these values.

In addition, some embodiments of the current invention have SIS-SCS 1250 that respond to abnormal conditions by locking out fuel flow (or other desired action, as disclosed in this document or known to those of ordinary skill in the art) if the VRU does not achieve a suitable vacuum upon connection to the tanker. The VRU must achieve this vacuum level before fuel flow starts. Otherwise, the situation could indicate a malfunction in the VRU or in the tanker-borne vapor system.

Another common malfunction is over pressure in the tanker-borne vapor system. A blockage in the VRU connection to the tanker or a VRU otherwise not providing sufficient vapor removal during the fuel transfer are both ways that overpressure may occur. The SIS-SCS 1250 can be adapted to monitor pressure sensors located in the compartments of the tanker or in the tanker-borne vapor system and shut down fuel flow (or other desired action, as disclosed in this document or known to those of ordinary skill in the art) if the pressure exceeds a preset value.

The SIS-SCS 1250 can be configured to monitor any number of variables surrounding the material transfer process and to alarm or to end material transfer upon detecting an abnormal condition in one or more of the variables. In some embodiments, these variables are intrinsic to the transfer process. In other words, the variables are part of the material transfer process. Examples of intrinsic variables include the rate of valve closure, pressure in the vapor recovery system during material transfer, motor run command, etc. Extrinsic variables are those variables external to the material transfer process. Examples of extrinsic variables include tanker truck position, variables related to material spills in the material transfer facility, the identity of material already contained by the tanker truck

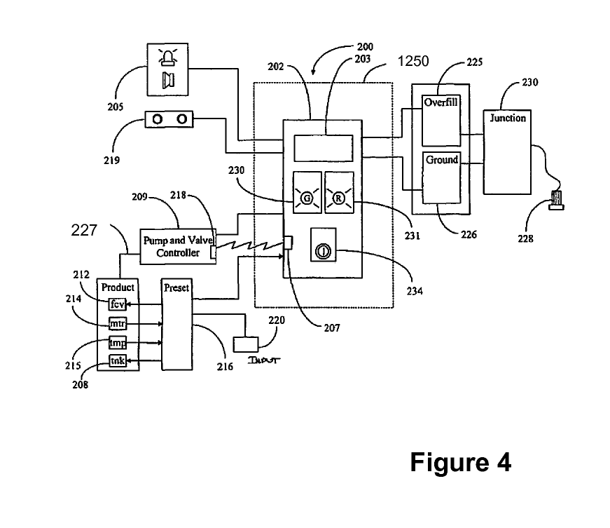

FIG. 4 is a block diagram of a fluid transfer operation and electronic monitoring and control system and a control monitor unit according to an embodiment of the present invention. FIG. 4 shows a fluid storage, pumping and transfer operation similar to system 100 of FIG. 3, system 200 having many similar control and monitoring elements as those shown in the previously described, prior art systems represented by FIG. 3. This system likewise incorporates overfill-detection unit 225 and ground detection unit 226 as safety devices in system 200. These units are similarly connected to a junction 230 providing connection between the circuitry of the monitoring and controlling units and plug assembly 228. System 200 receives signal inputs from sensors on the tank vehicle through plug assembly 228, which connects to a receptacle on the tank vehicle.

The monitoring and control or shutdown capability of system 200 is provided by overfill detection unit 225 and ground verification unit 226 in the system shown, as in previous systems such as is shown for system 100 of FIG. 3. In this example, however, the inventor provides an SIS-SCS 1250 that is in addition to the primary monitor and that provides many enhancements to previous and current systems. As will be described, the SIS-SCS 1250 has the capability to reliably, consistently, and intelligently monitor functions and conditions of the fluid storage and pumping operation, and has much broader control and system shutdown capability with greatly reduced reaction times in shutting down the transfer once a problem signal is interpreted.

SIS-SCS 1250 in this embodiment is a mountable unit similar in size and shape to that of a typical modern overfill-detection unit or static ground verification unit well known in the industry, and is similarly encased in a standard protective enclosure also common in the industry. SIS-SCS 1250 uses a central processor 202 and provides monitoring and controlling intelligence through firmware written specifically for its operation. SIS-SCS 1250 has circuitry connecting central processor 202 with the circuitry of overfill detection unit 225 and ground verification unit 226 as shown in this simplified view. In other embodiment of the present invention, additional circuitry may exist within SIS-SCS 1250 for connecting processor 202 to wiring for other similar signal input sources from additional units. For reasons of simplicity, however, such circuitry and units are not shown in this view.

Additional circuitry exists within SIS-SCS 1250 for connecting processor 202 to circuitry of emergency pump shutdown buttons 219, which have a similar manual system shutdown function as those of FIG. 3. Circuitry is also present in SIS-SCS 1250 for connecting to a material transfer gate, which in this case is a pump and valve controller 209 and batch controller preset 216. An interface 220 enables data to be manually input into batch controller preset 216 by a driver, for example. The valve controller 209 and batch controller preset 216 of system 200 monitor or send and receive control and pulsed signals to and from the fluid product storage and delivery systems, as is true in a typical application such as that of FIG. 3, and are shown connected through wiring to components related to the fluid product storage, pumping and delivery system, and operation. Shown are examples of such product-related components and again, for reasons of simplicity, the product components shown may represent a much larger number of components such as found in a typical application or installation.

Examples shown of such product storage and pumping components are flow control valve 212 and a flow meter 214, a fluid temperature probe 215 and a tank base valve 208, all having similar function and connectivity to batch controller preset 216 as the like components in system 100 of FIG. 3. But in the system shown, a connection 227 is used comprising an industry standard wiring system that connects between the product pumping and transfer components and pump and valve controller 209. Although it is not shown in this diagram, a motor control apparatus similar to motor control 111 of FIG. 3 can be assumed to be connected between pump and valve controller 209 and pump operations in the product components block and receives pump command signals from pump and valve controller 209 and executes the commands to the appropriate product pumps.

In this embodiment of the present invention, processor 202 of SIS-SCS 1250 may optionally communicate with pump and valve controller 209 through signals sent and received using RF wireless signal propagation. A radio transmit system 207 is provided in this embodiment for sending or receiving radio signals to pump and valve controller 209. Such signals may be control signals sent from SIS-SCS 1250 for controlling or shutting down pump and valve controller 209, or may be pulsed signals from a meter for monitoring by SIS-SCS 1250, or from some other signal source. A radio system 218 that is integrated with or otherwise connected to, circuitry of pump and valve controller 209, as with that of SIS-SCS 1250, receives or transmits control or pulsed signals, enabling the radio communication link. In some embodiments a radio-frequency transmit and receive system may be integrated into the design of SIS-SCS 1250 and pump and valve controller 218, or may be a generic, commonly available system that is purchased separately and simply connected, using standard methods, to the separate control units.

The use of radio signal transmission in conjunction with SIS-SCS 1250 for control of the pump and valve controller 209 or more generally primary monitor 1210, which is typically located near the vicinity of the loading operation, provides distinct advantages to systems of current and prior art that are connected through hard-wiring or Ethernet connections. For example, the greatly increased control range provided by such an arrangement enables a centralized and remote location to be chosen for SIS-SCS 1250, because the need for hard wiring or Ethernet connections to the pump and valve controller is eliminated. By locating SIS-SCS 1250 at a more distant, safer location away from the loading operation, at a remote monitoring station, for example, the safety to management and other pump station personnel is increased when an event occurs in presenting a hazard due to a product spill or vapor spray situation. Using such a method also allows management personnel an ability to assess and react to a hazardous situation much quicker than is currently possible using typical systems and methods because of the closer proximity of SIS-SCS 1250 to the management or monitoring personnel in a remote monitoring station. Generic radio transmit and receive systems that may be used with SIS-SCS 1250 and pump and valve controller 209 are inexpensive and commonly available allowing pump station upgrades that are both economical and easy to install.

In a typical application in a system such as is represented by system 200, overfill detection unit 225 is used in conjunction with ground verification unit 226 and, as a set, provides additional safety control and monitoring required for such an operation. In this example, a set comprising one overfill detection unit 225 and one ground verification unit 226 has the capability of monitoring and controlling from one to four individual sets of the various components for the pumping operation of one pump terminal. In some load lanes, however, as many as eight individual pump terminals may exist in a single loading lane. If such is the case, two sets of overfill detection and ground verification units are used, each set monitoring and controlling four individual sets of pumps, valves, meters, and other related components.

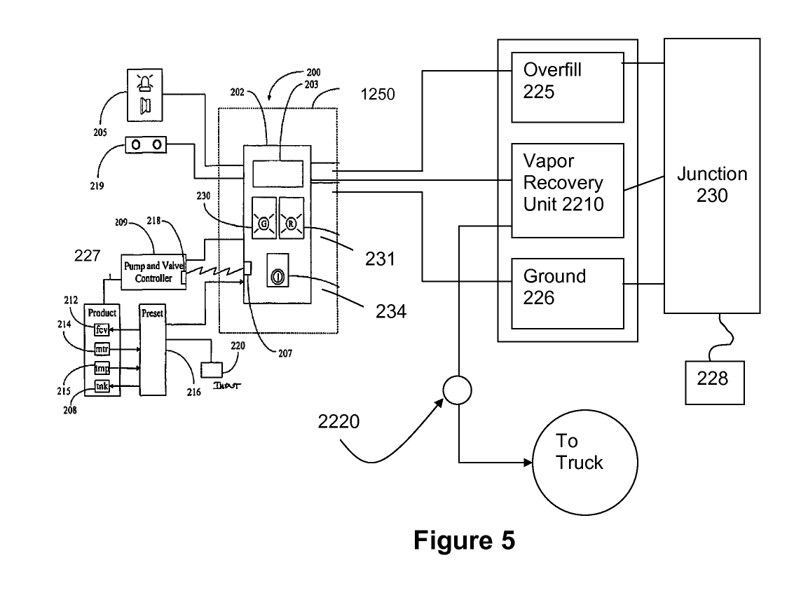

FIG. 5 illustrates a system similar to that of FIG. 4 except that a vapor recovery system or unit 2210 has been added to the facility. The monitoring and control or shutdown capability of system 200 is provided by overfill detection unit 225 and ground verification unit 226 in the system shown, but additionally the vapor recovery system 2210 can guard the fuel transfer process, as well. In this example, however, the inventor provides an additional pressure sensor 2220 on the input side of the vapor recovery system 2210. And SIS-SCS 1250 has additional software routines for interpreting the output from the pressure sensor 2220 and preventing fuel flow into the tanker when appropriate. Therefore, the SIS-SCS 1250 allows enhanced environmental protection against vapor releases, improves the operation of the overall vapor recovery system, and enables management to take control over this environmental aspect of material transfer.

SIS-SCS 1250 greatly extends monitoring and control capability by providing a method for continuously monitoring the output signals from one or two sets of overfill detection and static ground verification units, and by having the capability of monitoring from one to eight individual product meter pulses originating from meters 214, and a same number of associated pump commands sent from batch controller preset 216. The monitored product meter pulses may be from presets or meters that are of either mechanical or electronic design. SIS-SCS 1250, by having direct connection, through either standard wiring, Ethernet, or radio signal propagation, to pump and valve controller 209 and batch controller preset 216, provides control for a much broader range of pump, valve, or meter components. If the condition of a signal monitored by SIS-SCS 1250 indicates a problem or hazardous condition, whether the signal source is from the overfill detection or ground verification units, or from a controller or preset, the reaction time of the component or system receiving the resulting shutdown command signal from SIS-SCS 1250 is greatly reduced. In this manner, the amount of fluid that continues to flow after the hazardous signal condition is interpreted by SIS-SCS 1250 and power has been cut to the associated transfer apparatus, is greatly reduced as compared to conventional systems not using a SIS-SCS 1250. This is because additional connection circuitry is needed to accommodate sets of overfill detection, ground verification units, and vapor recovery systems, each of which often controls separate pump, valve or terminal operations on separate connection circuitry. In such conventional systems, the additional connection circuitry and components result in an indirect and inefficient signal path, adding to system reaction time in the event of a shutdown, while increasing the chance of malfunction or failure of components of the system.

SIS-SCS 1250 is provided with a display 203, which is, in this embodiment, a liquid crystal display well known in the industry. But in alternative embodiments, the type of display may vary. Display 203 is electronically connected to circuitry of processor 202 and is mounted in or on the housing of SIS-SCS 1250, as will be subsequently shown in detail. SIS-SCS 1250 is mounted so that in operation, display 203 is clearly visible to the operator or other personnel monitoring the unit. Some signals received and interpreted by processor 202 from the various signal inputs from the pump and transfer system or control monitors are analyzed by processor 202 and displayed by display 203. For example, one such signal is received by processor 202 from a component of the pump terminal, such as a meter, and processor 202 displays the number of the active pump using display 203. Display 203 may also show other indicators, such as blinking or otherwise animated flow indicators, product flow volume, in gallons, that occurs after a valve shutdown, and many other such indicators of operational status. In this way, periodic and accurate adjustment and tuning of the valves or pumps in the system may be performed based on such indicators displayed by display 203. Other indicators displayed by processor 202 through display 203 include but are not limited to those described, and may vary depending on different firmware that may be used by processor 202 in its operation. In one embodiment, processor 202 uses display 203 indicators for relaying vapor recovery system data.

Hazardous conditions may develop in the operation of a petroleum or petrochemical fluid storage and transfer system. For example, management personnel must immediately learn of conditions such as overfill, static ground loss, or vapor recovery malfunction as soon as they occur. Visible and audible alarms must make the condition immediately apparent to ensure that the condition is known. Some embodiments of SIS-SCS 1250 have a pair of status indicators, located and mounted below display 203 so that management immediately learns of the hazardous condition or malfunction. For example, in the embodiment shown, status indicator 230 has a light behind a translucent green lens, and during normal operation, when processor 202 interprets overfill and static ground signals as normal and indicating no problem, the light in indicator 203 remains in the on position, illuminating the green lens and providing a visual confirmation of the normal and safe operation of the system. In some embodiments, an alarm indicator is provided by status indicator 231 located below display 203, next to status indicator 230, and is used for providing the visual signal that an abnormal condition exists or is developing. As an example, if processor 202 detects the signals from ground verification unit 226 and the pulsed flow signals from batch controller preset 216 as normal, but the signal from overfill detection unit 225 as deviating from its normal condition, status indicator 231 provides the visible alarm to monitoring personnel using a flashing light behind a red lens. By using indicators 230 and 231, a rapid visual confirmation can be made by management personnel that the system is operating normally and safely. The system 201 through these indicators immediately makes hazardous conditions visually apparent.

The circuitry of processor 202 in the embodiment shown also has the capability of connecting to, and sending signals to, an alarm system 205, which is located external to SIS-SCS 1250. Alarm system 205 may be a visual flashing light or beacon, an audible alarm, or a combination of these. It may be located in multiple areas remotely from SIS-SCS 1250. In this manner, the level of awareness of management and other monitoring or operating personnel to the operating status of the system is greatly increased.

A keyed reset switch 234 is provided in this embodiment for the purpose of allowing a manual reset of the operation, settings or display characteristics, for example of SIS-SCS 1250. Reset switch 234, when actuated, is designed to reset SIS-SCS 1250 from an alarm condition enabling only specified personnel having the proper key, to reset or restart the system. Other alternative embodiments of the present invention may use a different control mechanism than keyed reset switch 234, one example being a keypad where a multi-digit code is entered for actuation of the reset action. Regardless of the mechanism, the control reset function described for this embodiment allows only personnel qualified for resetting the system to do so.

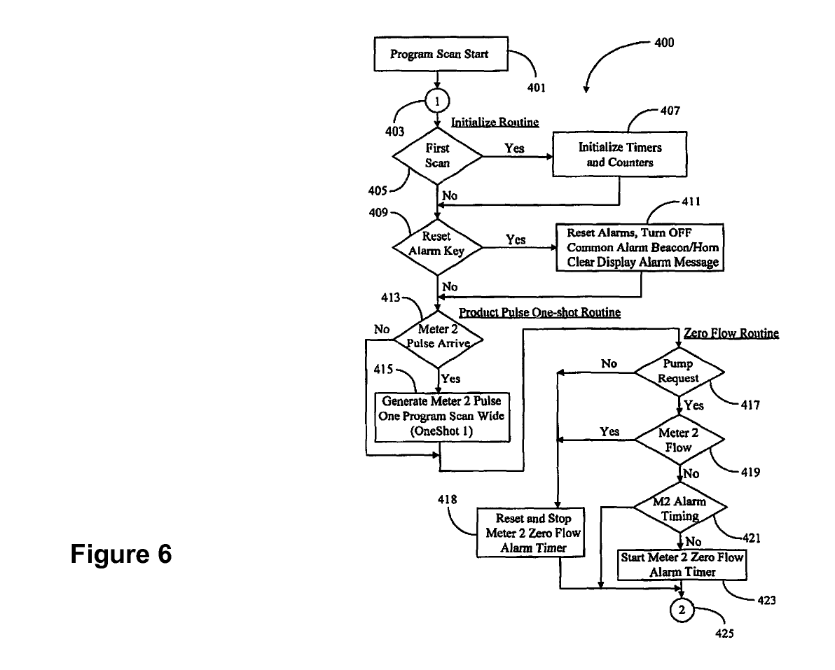

FIG. 6 is a flow diagram illustrating logic of some firmware routines of SIS-SCS 1250 in an embodiment of the invention. The logic flow illustrated represents the firmware that drives the function of processor 202 of SIS-SCS 1250. Firmware 400 comprises a number of steps and branching conditions and instructions that direct the logic flow through the correct series of functions depending on the various conditions. As shown in FIG. 6, the beginning point, or program start portion, of the firmware program is shown as step 401, which begins the first section of the firmware logic represented by section 403. The firmware portion begins with an initialization routine on all of the program variables, then, in step 405, a determination is made if the routine is a first program scan. If so, the process of initializing timers and counters begins in step 407. If a determination is made in step 405 that it is not the first scan, step 409 checks if the reset alarm key switch has been activated. If the reset alarm key switch has been activated, step 411 begins by resetting the alarms of SIS-SCS 1250, turning off a common connected alarm system external to SIS-SCS 1250, such as a flashing beacon and horn system, for example, and clearing any alarm message displayed by display 203 of SIS-SCS 1250.

If a reset alarm key switch has not been activated, a product pulse routine begins; referred to by the inventor as a one-shot routine, beginning in step 413 where a check is made whether or not a product pulsed signal from a flow meter has just arrived. If so, a product pulse scan routine, referred to as one-shot routine by the inventor, begins in step 415, otherwise, the firmware program begins the next routine for checking zero-flow conditions. The zero-flow routine begins in step 417 where it is determined whether the meter's associated preset/batch control/other device requesting flow has signaled a request for a product pump to be turned on. And if it has, a check is made in step 419 if the flow meter is measuring actively flowing product. If no product pump request has been received by processor 202 from the meter's associated preset/batch control/other device requesting flow, the action of resetting and stopping the second meter zero-flow alarm timer takes place in step 418. In step 419, if it is determined that the flow meter is not actively flowing product step 421 checks the operation of the zero-flow alarm timer of the flow meter to determine whether or not the timer is on. If the zero-flow alarm timer of the meter is not timing step 423 starts the alarm timer for the flow meter, otherwise the firmware arrives at section 425 to begin the second logic phase of firmware 400.

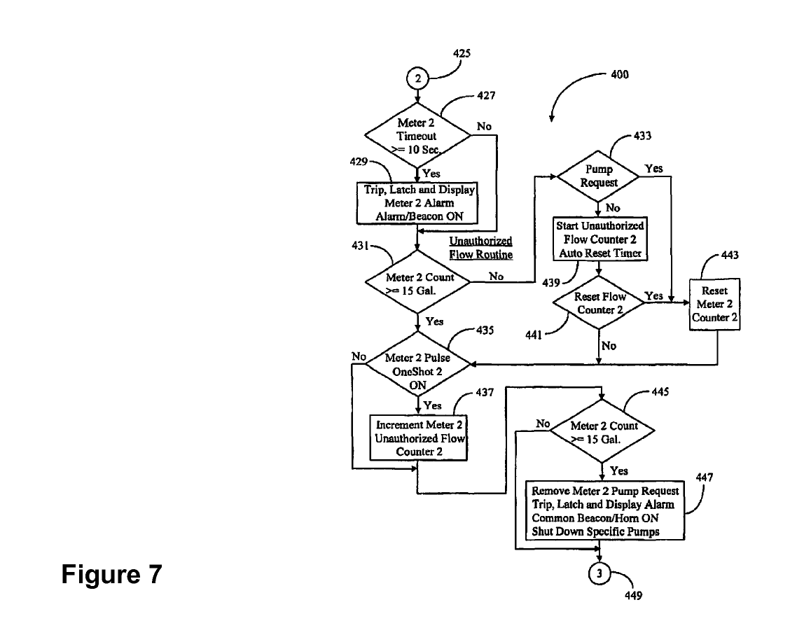

FIG. 7 is a flow diagram illustrating additional logic of the firmware routines of SIS-SCS 1250, and is a continuation of the flow logic of FIG. 6, beginning at section 425 to be in the second logic phase of firmware 400. The first step 427 in this phase firmware 400 checks if the zero-flow alarm timer of the flow meter has timed out, making the determination based on if timing of the alarm timer has ceased for a period of time greater than or equal to 10 seconds. If the duration of the timeout meets or exceeds 10 seconds, the zero-flow alarm is tripped, latched, and indicated by display in step 429, and in this step, an external visible and audible alarm system is activated, such as a horn and light beacon. If the alarm timer timeout does not exist, or is of duration of less than 10 seconds, a next routine begins in firmware 400 that is used for checking unauthorized product flow. The unauthorized flow routine begins in step 431 where a flow count is checked for the flow meter, and it is determined whether or not the unauthorized flow counter reads a volume greater than or equal to 15 gallons. If the reading is less than 15 gallons, step 433, if the pump motor for the flow meter has sent a request for the pump to be turned on. If the pump request has been sent, in step 443, the unauthorized flow counter for the flow meter is reset, and step 435 begins where it is determined whether a routine is taking place, referred to by the inventor as one-shot 2 routine.

If a request to turn the product pump on has not been sent from the meter's associated preset/batch control/other device requesting flow as determined in step 433, an automatic reset timer is started for the flow counter in step 439. Step 441 then determines if the current time is appropriate for starting the automatic reset timer for the flow counter. If conditions are appropriate for starting the flow counter reset timer, resetting of the timer takes place in step 443, otherwise the determinations of step 435, as described earlier, take place. If the conditions of the product pulse signals from the flow meter, in step 435, are such that it is determined that the one-shot 2 routine is running, the unauthorized flow counter for the flow meter is incremented in step 437. It is then determined in step 445 whether the count for the unauthorized flow counter meets or exceeds 15 gallons or whatever count meets the needs of the particular process. If the conditions of the product pulse signals are such that it is determined in step 435 that the one-shot 2 routine is not running, step 445 begins for measuring the unauthorized flow count. In step 445 it is determined that the flow count as reported by the flow counter meets or exceeds 15 gallons, step 447 begins where the product pump request for the flow meter is removed, the unauthorized flow alarm is tripped, latched and indicated as such by display 203 of SIS-SCS 1250, and a common external beacon and horn alarm system, for example, is activated. Unauthorized product flow is stopped in this step by a signal sent to the pump controller in the system to instantly shutdown the specific pump or pumps where the unauthorized flow is occurring. The pump controller shuts down the product pumps by interrupting the power to the systems. Firmware 400 then arrives at the next phase represented by section 449, which begins another firmware routine.

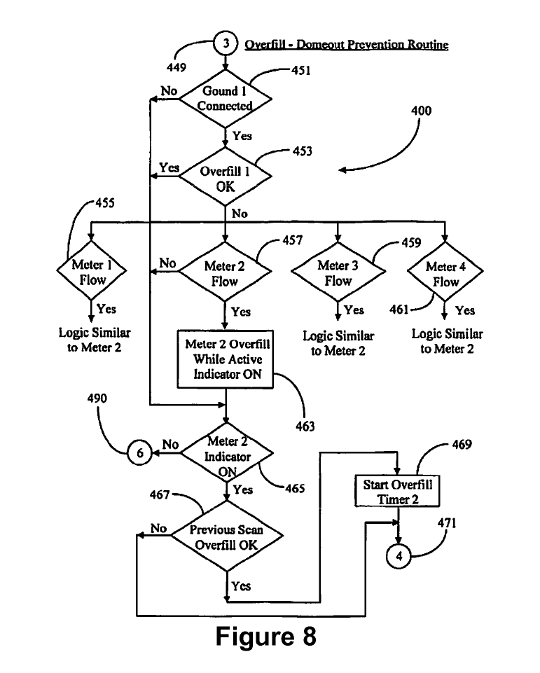

FIG. 8 is a flow diagram illustrating additional steps of the firmware routines of SIS-SCS 1250, and represents a next phase in firmware 400 where a safety routine begins for detecting the conditions of product overfill and static ground. The routine, referred to by the inventor as the overfill dome out prevention routine, begins at section 449 and has a first step 451 that determines, based on a signal sent from the ground verification unit of the system, if a static ground exists for the specific pump terminal and tanker being loaded at the terminal. If static ground is detected in step 451, an assessment of the operation of the overfill detection unit of the system is made in step 453. If, in step 451, it is determined that a proper ground condition does not exist for that pump terminal, step 465 checks if an indicator for the flow meter is on signify an “overfill while active” condition.

If the overfill signals in step 453 do not indicate a problem, step 465 begins, otherwise, step 457 checks if product is actively flowing from the product flow meter. If it is determined in step 457 that product is actively flowing then the indicator for “overfill while active” for the product meter is turned on in step 463. If it is determined in step 457 that product is not actively flowing, then step 465 begins by checking if the “overfill while active” indicator is on. In step 465, it is determined that the “overfill while active” indicator is operating, step 467 checks what the conditions of the overfill signals were in the previous scan in step 453. And in step 467, if signal conditions indicated no problems, step 469 starts an overfill timer for the product pump, arriving at the next phase of firmware 400 represented by section 471. If conditions of the overfill signals of the previous scan did indicate problems, then step 469 is bypassed and a next phase of firmware 400 begins at section 471. If, in step 465, it is determined that the “overfill while active” indicator is not on, a phase in firmware 400 is reached indicated by section 490 where a routine will begin to run for the LCD display, being described later in greater detail.

Referring now to step 457, which determines if product is or is not actively flowing for a particular meter, the same flow logic that is used by firmware 400 beginning at step 457, being dependent on the results of the flow determination made there, is also used for additional meters monitored and controlled by the firmware. In the example shown, three additional meters are monitored and controlled by firmware 400, each using a step similar to step 457. A step 455 begins the logic flow for a first meter, step 457 as described for a second meter, a step 459 for a third meter, and step 461 for a fourth meter. For example, if in step 455 for a first flow meter, if it is determined that product is actively flowing for that meter step 463 begins for that meter, and if product is not actively flowing, then step 465 begins for that meter. The same logic is applied to all four of the meters represented in the flow diagram.

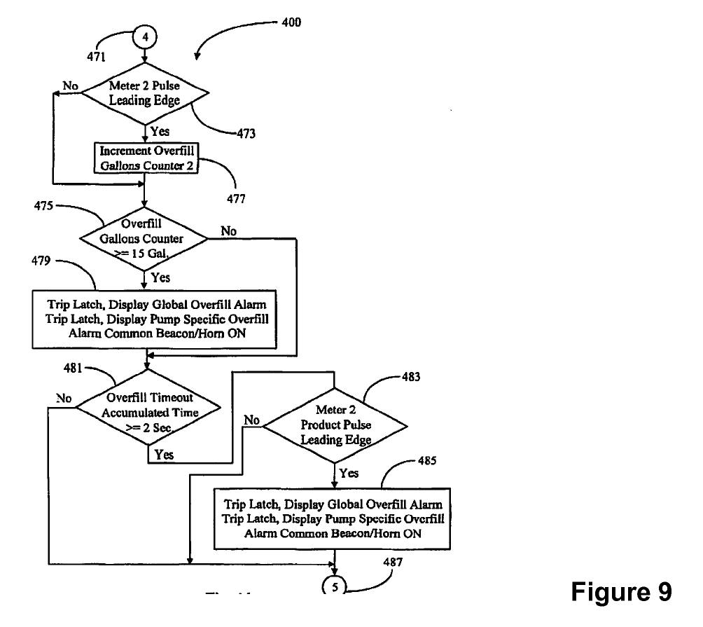

FIG. 9 is a flow diagram illustrating additional logic of the firmware routines of SIS-SCS 1250. The logic flow for firmware 400 shown in this diagram begins at section 471 where in step 473 a determination is made of the product pulse from the flow meter if the leading edge of the product pulse has been received. If it is determined that the leading edge of the product pulse from the flow meter is present, then step 477 increments the overfill gallons counter for the product pump, and step 475 begins to determine whether or not the count from the gallons counter indicates a flow volume greater than or equal to 15 gallons. If the leading edge of the product pulse is not present, step 477 is bypassed and step 475 begins as described. In step 475, it is determined that the count for the overfill gallons counter meets or exceeds 15 gallons, then step 479 begins where a global overfill alarm system is tripped, latched and indicated as such by display 203 of SIS-SCS 1250, shutting down all product pumps. A pump specific overfill alarm is also tripped, latched and displayed in this step, and a common external beacon/horn alarm is activated at this time.

The next logic step in this phase of firmware 400 occurs in step 481 where it is determined whether or not the overfill timer for the product meter has timed out for a period of accumulated time greater than or equal to 2 seconds. If two seconds or more have elapsed during a timeout then step 483 begins which determines whether the product pulse from the meter is at its leading edge. If, in step 481, the timeout period is determined to be less than two seconds of then a phase of firmware 400 represented by section 487 is reached which will be subsequently described in detail. If the product pulse from the flow meter is determined to be at the leading edge in step 483, then a step 485 begins, comprising an identical set of actions to that of step 479. Once these actions are completed, firmware 400 reaches the next phase indicated by section 487.

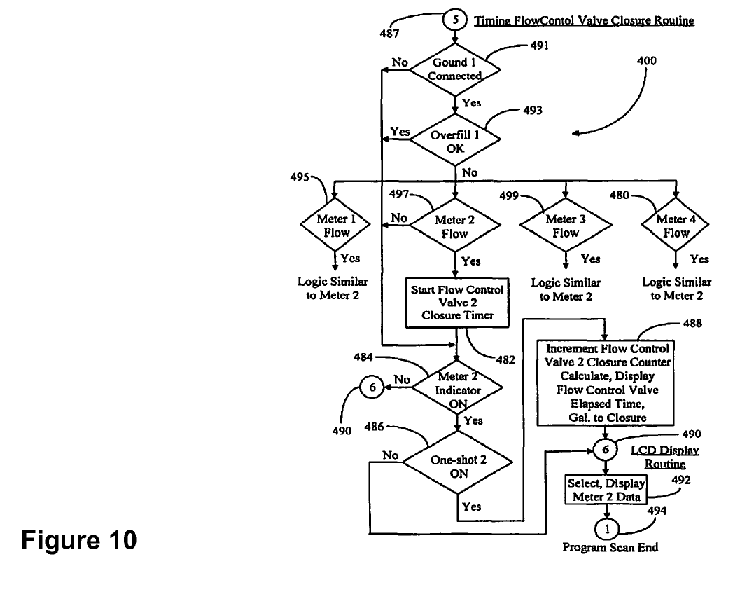

FIG. 10 is a flow diagram illustrating additional logic of the firmware routines of SIS-SCS 1250. At the phase represented by section 487 in this view, firmware 400 begins a timing routine for the closure of a specific flow control valve. The timing-flow-control-valve-closure routine begins in step 491 where the static grounding condition for the equipment being monitored and controlled is verified by interpreting a signal sent by a ground verification unit in the system. If the static grounding signals in step 491 indicate that proper grounding exists, step 493 checks the signals from an overfill detection unit for a problem indication. In step 491, if the signals from the ground verification unit indicate that a static ground is weak or not present, step 484 begins which determines if the “overfill while active” indicator is on.

In step 493, if the signals from the overfill verification unit indicate that no problem exists, step 484 begins as described above. If, in step 493, the overfill signals do indicate a problem, a check is made in step 497 whether or not there is actively flowing product for that meter. As is true for the logic flow illustrated by FIG. 8 for the overfill time out prevention routine, a step identical to step 497, and similar following logic are used for each of an additional three meters, as shown by their respective steps 495 for a first meter, step 497 for a second meter as described, step 499 for a third meter and step 480 for a fourth meter.

In step 497, if it is determined that the flow meter is actively flowing product, a closure timer for the flow control valve is started in step 482. If it is determined in step 497 that at the flow meter there is not product actively flowing, step 484 determines if the “over the while active” indicator is on. In step 484, if it is determined that the “overfill while active” indicator is on, then step 486 begins which determines if the product pulse from the flow meter is at the leading, or rising edge, meaning that the one-shot 2 routine is on. If indications are, in step 484 that the “overfill while active” indicator is not on, the next phase of the flow logic of firmware 400 is reached, indicated as section 490, which begins a LCD display routine.

If it is determined in step 486 that the product pulse is at the leading edge and the one-shot 2 routine is on, step 488 begins by incrementing the flow control valve closure counter, and calculating and displaying the elapsed time and number of gallons before closure of the flow control valve. If it is determined in step 486 that the product pulse is not at the leading edge and the one-shot 2 routine is not running, the next phase beginning the LCD display routine represented by section 490 is reached. The LCD display routine at section 490 of firmware 400 begins in step 492 where display 203 of SIS-SCS 1250 displays various data from the product flow meter. A phase in firmware 400, represented by section 494, ends the program scan, which then may begin again at the program scan start for the running of an initialization routine.

It will be apparent to the skilled artisan that many variations may exist within the firmware used by the processor of SIS-SCS 1250, depending on the application and environment in which SIS-SCS 1250 operates, and the various equipment that may be used in the operation. For example, a different number of product pumps, associated components and ground or overfill verification units may be monitored and controlled by firmware 400. Moreover, firmware 400 may be designed to control functions of the central processor of SIS-SCS 1250, so that SIS-SCS 1250 may operate in conjunction with safety equipment such as overfill verification and ground detection units of different types from a variety of manufacturers. There are many ways that functionality may be provided by the firmware in the processor, while accomplishing essentially the same purpose or function within the scope and spirit of the present invention. Similarly, there are many ways that the firmware may be programmed and structured by different programmers, or the same programmer, while still accomplishing essentially the same purpose or function. Such variations should be considered within the scope of the invention, and the invention is limited only by the claims that follow.

In some embodiments, the SIS-SCS 1250 is configured to record various parameters related to the material transfer process including transaction-by-transaction parameters. In some embodiments, a transaction, as monitored by the SIS-SCS, begins when fuel flow starts and ends when the hard-wired electrical connection and, for embodiments in which the material being transferred is fuel, the fuel hose is disconnected. In some embodiments, the SIS-SCS 1250 records the amount of material transferred, the identity of the tanker, the pressure inside the tanker compartments, and truck loading position. The SIS-SCS 1250 also records when fuel was ordered to start by the preset, the time that fuel begins flowing, the time the preset orders fuel to cease flowing, the time fuel flow stops, and the date and time of the fuel transfer.

Additionally, the SIS-SCS 1250 records the fuel type, facility ID, fuel temperature for the transfer. Also, the SIS-SCS 1250 record events such as failure mode or alarms.

In some embodiments, the SIS-SCS 1250 is adapted to communicate with the tanker to read ID data from the tanker and data such as the fuel type stored in the compartments. In some of these embodiments, RFID technology facilitates this communication.

Any of the data recorded for a transaction can be transferred offsite for archival purposes or for further remote analysis. This data can be transferred using any number of methods (either wired or wireless) as are standard in the computer arts. The distance separating the SIS-SCS 1250 from the remote storage can range from inches to many miles depending on the needs of a particular material transfer facility.

Embodiments of the SIS-SCS 1250 may be adapted for tankermounted operation. In such an embodiment, the supervisory nature of the system would supervise the manual transfer of fuel from the tanker to the underground tanks at automobile filling station.

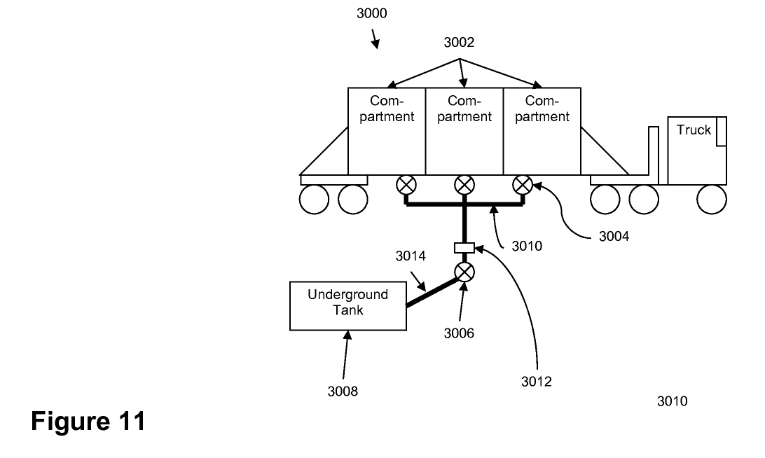

FIG. 11 shows a block diagram representing a typical tanker 3000. As can be seen, the tanker 3000 has compartments 3002. Each compartment 3002 is connected to a pipe manifold 3010 used to connect the compartments 3002 to underground tank 3008. A safety valve 3004 is disposed between the compartments 3002 and the underground tank 3008. The safety valve 3004 is designed not to open until various conditions of the tanker 3000 are suitable for fuel transfer. One such condition is that the parking brake of the truck (not shown) that transports the tanker 3000 must be activated.

A manual valve 3006 is disposed between the manifold 3010 and the underground tank 3008. Typically, the manual valve 3006 is manually controlled by the tank operator. Hose 3014 connects manifold 3010 with the underground tank 3008. The manifold 3010 contains a meter 3012. This meter 3012 allows the operator to measure the amount of fuel transferred from the compartment 3002 to the underground tank 2008.

Most fuel spills that occur when transferring fuel to the underground tank 3008 occur due to operator error. For example, the operator may incorrectly calculate the amount of fuel to be delivered, thereby causing an over fill of the underground tank 3008. Alternatively, the operator may incorrectly connect hose 3014 to the underground tank 3008 causing a leak. In other cases, fuel spills may be caused by equipment malfunction such as a failure of manual valve 3006.

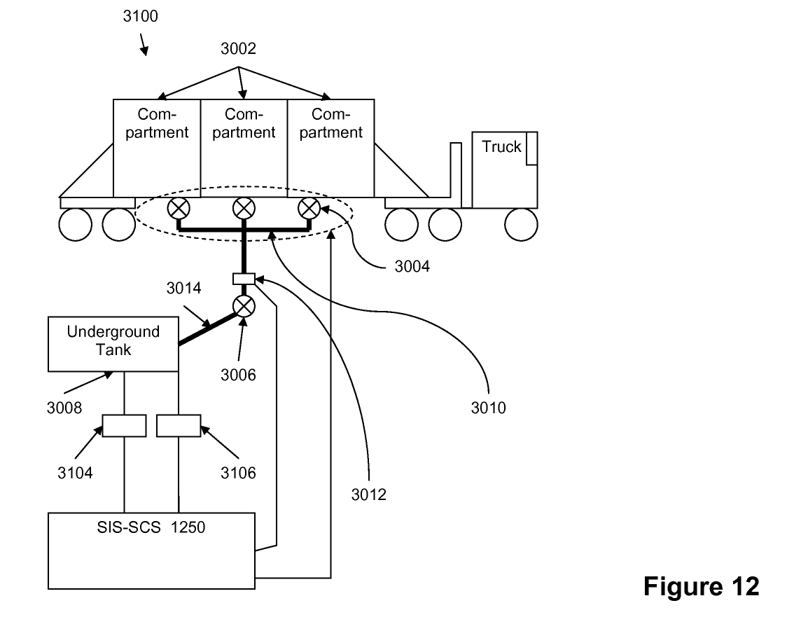

FIG. 12 shows a tanker 3100 similar to the prior art tanker 3000 except that tanker 3100 contains an embodiment of the invention SIS-SCS 1250. FIG. 12 shows fuel-level probe 3104 and spill-detector 3106, which are part of SIS-SCS 1250. FIG. 12 also shows that safety valves 3004 are under the control of SIS-SCS 1250 and that meter 3012 is connected to SIS-SCS 1250, as well.

In operation, SIS-SCS 1250 of FIG. 12 is configured to monitor meter 3012, fuel-level probe 3104, and spill-detector 3106. If the SIS-SCS 1250 registers an abnormal value from one or more of meter 3012, fuel-level probe 3104, or spill detector 3106, it issues an alarm, shuts down fuel flow, or both. In some of these embodiments, the SIS-SCS 1250 shuts down fuel flow by causing safety valves 3004 to close (or removing the signal that allows safety valve 3004 to remain open). If no abnormal values are encountered, the typical fuel transfer apparatus operates normally with the SIS-SCS 1250 silently watching the transfer.

In operation, the SIS-SCS 1250 of FIG. 12 monitors the meter 3012, the fuel-level probe 3104, or the spill detector 3106. If an abnormal condition occurs on one of these, the SIS-SCS 1250 removes the signal that allows safety valve 3004 to open, which causes valve 3004 to close. Exemplary abnormal conditions include the fuel-level probe 3014 detecting a level over that desired or spill detector 3106 registering liquid fuel on the ground. Fuel-level probe 3104 and spill detector 3106 connect to SIS-SCS 1250 through either wired or wireless connections.

While particular embodiments of the present invention have been shown and described, it will be obvious to those skilled in the art that changes and modifications can be made without departing from the embodiments of this invention in its broader aspects and, therefore, the appended claims are to encompass within their scope all such changes and modifications as fall within the true spirit and scope of the embodiments of this invention. Additionally, various embodiments have been described above. For convenience's sake, combinations of aspects composing invention embodiments have been listed in such a way that one of ordinary skill in the art may read them exclusive of each other when they are not necessarily intended to be exclusive. But a recitation of an aspect for one embodiment is meant to disclose its use in all embodiments in which that aspect can be incorporated without undue experimentation. In like manner, a recitation of an aspect as composing part of an embodiment is a tacit recognition that a supplementary embodiment exists that specifically excludes that aspect. All patents, test procedures, and other documents cited in this specification are fully incorporated by reference to the extent that this material is consistent with this specification and for all jurisdictions in which such incorporation is permitted.

Moreover, some embodiments recite ranges. When this is done, it is meant to disclose the ranges as a range, and to disclose each point within the range, including end points. For those embodiments that disclose a specific value or condition for an aspect, supplementary embodiments exist that are otherwise identical, but that specifically exclude the value or the conditions for the aspect.

What is claimed is:

1. A supervisory independent secondary shutoff control system (SIS-SCS) that interfaces with at least one stream in a material transfer facility, each stream of material transfer with one or more components including
a transfer apparatus composed of one or more material transfer components that are adapted to transfer material from a first material region to a second material region; and
a primary monitor adapted to control the transfer apparatus
wherein the SIS-SCS is adapted to send signals to the primary monitor or the transfer apparatus wherein the signals include signals instructing the transfer apparatus or primary monitor to end material transfer or signals allowing or forbidding material transfer or any combination of these signals.

2. The SIS-SCS of claim 1 wherein the SIS-SCS executes software routines that cause the SIS-SCS to monitor signals from the primary monitor or the transfer apparatus and cause the SIS-SCS to send signals instructing the transfer apparatus or primary monitor to end material transfer, signals allowing material transfer, signals forbidding material transfer, or any combination of these signals.

3. The SIS-SCS of claim 1 adapted to receive data from a vapor recovery system of a material transfer facility wherein the vapor recovery system comprises a pressure transducer upstream of an inlet filter.

4. The SIS-SCS of claim 3 adapted to initiate a signal communication when the pressure transducer registers a spike in pressure.

5. The SIS-SCS of claim 3 adapted to initiate a signal communication when the pressure transducer registers a pressure exceeding a pre-selected pressure.

6. The SIS-SCS of claim 3 wherein the pre-selected pressure is 18, 16, 14, 12, or 10 inches of water.

7. The SIS-SCS of claim 3 adapted to send signals forbidding material transfer when the pressure in the vapor recovery system fails to reach a pressure below a pre-selected pressure or adapted to send signals generating an alert when the pressure in the vapor recovery system fails to reach a pressure below a pre-selected pressure.

8. The SIS-SCS of claim 7 where in the pre-selected pressure is 18, 16, 14, 12, or 10 inches of water.

9. The SIS-SCS of claim 8 wherein the material of the material transfer facility is fuel or a petroleum-based product.

10. The SIS-SCS of claim 8 wherein the material of the material transfer facility is intended for animal or human consumption.

11. The SIS-SCS of claim 1 further adapted to receive input signals from the material transfer facility including signals from the primary monitor, the transfer apparatus, or other material transfer facility component;
to execute software routines based on input signals; and
to send signals to end material transfer; signals allowing material transfer; signals forbidding material transfer; or any combination of these signals.

12. The SIS-SCS of claim 11 wherein other material transfer facility components include a vapor recovery system comprising a pressure transducer upstream of an inlet filter and input signals include signals from the pressure transducer.

13. The SIS-SCS of claim 12 adapted to signal an alert or shutdown material flow when the transducer registers a spike in pressure or send signals forbidding material transfer or generating an alert when the pressure in the vapor recovery system fails to reach a pressure below a pre-selected value.

14. The SIS-SCS of claim 1 wherein the SIS-SCS interfaces with at least one stream in a fluid transfer facility, each fluid stream with one or more components including
a flow control device;
a pump and valve controller system (PVS) connected to the flow control device, with a secondary flow control valve connected to the flow control valve, a pump connected to the secondary flow control valve and a product storage tank, and a motor control connected to the pump;
at least one of
a ground verification connected to the PVS:
an overfill detection system connected to the PVS; or
a vapor recovery system connected to the PVS,
wherein the flow control device is adapted to send signals to the PVS and the PVS is adapted to respond to signals from the flow control device and,
wherein the SIS-SCS connects to the PVS and is adapted to enable or disable pumping; open or close the secondary control valve or any combination of these in response to any combination of signals from the ground verification system, the overfill detection system or the vapor recovery system.

15. A method of preventing fuel spills in a fuel transfer station having fuel transfer components, an overfill detection unit that signals fuel overfill and a vapor recovery system that measures vapor recovery system pressure, wherein the method comprises:
beginning fuel transfer;
monitoring signals from the overfill detection unit and the vapor recovery system during fuel transfer; and
ending fuel transfer after observing a pressure spike in the vapor recovery system pressure.

16. The method of claim 15 wherein the step of ending fuel transfer comprises
registering a pressure spike in the vapor recovery system;
monitoring the fuel transfer components to predict time until the end of fuel transfer;
initiating secondary shutdown of fuel flow if time is greater than a predetermined value.

17. The method of claim 16 wherein the steps of registering, monitoring and initiating are carried out by a supervisory independent secondary shutoff control system (SIS-SCS) that interfaces with at least one fuel stream in a fuel transfer facility, each stream of material transfer with one or more components including
a transfer apparatus composed of one or more material transfer components that are adapted to transfer material from a first material region to a second material region; and
a primary monitor adapted to control the transfer apparatus
wherein the SIS-SCS is adapted to send signals to the primary monitor or the transfer apparatus wherein the signals include signals instructing the transfer apparatus or primary monitor to end material transfer or signals allowing or forbidding material transfer or any combination of these signals.

18. A method of preventing fuel spills in a fuel transfer station having a vapor recovery system that measures vapor recovery system pressure with a pressure transducer upstream of an inlet, wherein the method comprises:
monitoring the pressure in the vapor recovery system;
sending signals forbidding fuel transfer if the pressure falls below a pre-selected value.

19. The method of claim 18 wherein the steps of monitoring and sending are carried out by a supervisory independent secondary shutoff control system (SIS-SCS) that interfaces with at least one fuel stream in a fuel transfer facility, each stream of material transfer with one or more components including
a transfer apparatus composed of one or more material transfer components that are adapted to transfer material from a first material region to a second material region; and
a primary monitor adapted to control the transfer apparatus
wherein the SIS-SCS is adapted to send signals to the primary monitor or the transfer apparatus wherein the signals include signals instructing the transfer apparatus or primary monitor to end material transfer or signals allowing or forbidding material transfer or any combination of these signals.

20. The SIS-SCS of claim 1 wherein the system interfaces with at least one stream of fluid transfer in a fluid transfer facility, each stream of fluid transfer with (i) a flow control device that is either a start/stop switch or a batch controller system that includes an optional preset in communication with a meter, and a flow control valve connected to the meter; (ii) a pump and valve controller system, in communication with the batch controller system, the flow control device, the pump and valve controller system with a secondary flow control valve connected to the flow control valve, a pump connected to the secondary flow control valve and to a product storage tank, and a motor control connected to the pump; (iii) an emergency shutdown circuit or emergency fuel shut off circuit connected to the pump and valve controller system; (iv) a ground verification unit connected to the pump and valve controller system; and (v) an overfill detection system connected to the pump and valve controller system, wherein the batch controller system is adapted to send operation signals to the pump and valve controller system and the pump and valve controller system is adapted to respond to operation signals from the batch controller system wherein the operation signals include signals to start the pump, signals to open the flow control valve, or both of these signals,
the system comprising a monitoring system in communication with a supervisory pump and valve control system, or the emergency shutdown circuit or emergency fuel shut off circuit, or both
the monitoring system including
a input channel connected to the meter;
an input channel connected to the overfill-detection system, the ground-verification-unit, or both;
an output channel;
executable software routines adapted to process signals received through any of the input channels;
executable software routines adapted to sending signals through the output channel to the supervisory pump and valve control system, to sending signals through the output channel for activating the emergency shutdown circuit or emergency fuel shut off circuit, or to sending signals through the output channel to both; and
the supervisory pump and valve control system connected to the pump and valve controller system and adapted to
receiving signals from the monitoring system;
enabling or disabling pumping in response to the signals; and
opening or closing the secondary flow control valve in response to the signals.
